(19) United States
(12) Patent Application Publication
(10) Pub. No.: US 2017/0279190 A1
(43) Pub. Date: Sep. 28, 2017

(54) ANTENNA DEVICE AND PORTABLE WIRELESS DEVICE USING THE SAME

(71) Applicant: TDK Corporation, Tokyo (JP)

(72) Inventors: Toshifumi KOMACHI, Tokyo (JP); Toshio Tomonari, Tokyo (JP); Hirohumi Asou, Tokyo (JP)

(73) Assignee: TDK Corporation, Tokyo (JP)

(21) Appl. No.: 15/461,267

(22) Filed: Mar. 16, 2017

(30) Foreign Application Priority Data
Mar. 22, 2016 (JP) 2016-056439

(51) Int. Cl. H01Q 1/38; H01Q 7/00; H01Q 1/24

(52) U.S. Cl. CPC H01Q 1/38; H01Q 1/242; H01Q 7/00

(57) ABSTRACT

Disclosed herein is an antenna device that includes a metal layer, a substrate, and a solenoid coil wound around the substrate. At least a part of a spiral coil is formed by a conductor pattern constituting the solenoid coil, and at least a part of the spiral coil is covered by the metal layer.

### BACKGROUND OF THE INVENTION

Field of the Invention

The present invention relates to an antenna device and a portable wireless device provided with the antenna device and, more particularly, to an antenna device including a solenoid coil and a spiral coil and a portable wireless device provided with the antenna device.

Description of Related Art

In recent years, an RFID (Radio Frequency Identification) system is implemented in a portable wireless device such as a smartphone, and such a portable wireless device is provided with an antenna device for performing near field communication with a reader/writer as a communication means. As an antenna device of such a type, an antenna device described in Japanese Patent Application Laid-open No. 2007-012689 is known.

On the other hand, in recent years, in view of thinning, light-weighting, durability against impact at the time of falling, and designability, the casing of the portable wireless device is often made of a metal. However, when the antenna device described in Japanese Patent Application Laid-open No. 2007-012689 is disposed at a position covered by the metal casing, the metal casing serves as a shield against magnetic flux to hamper proper communication. Thus, it is necessary to locate the antenna device at a position not covered by the metal casing and, therefore, the degree of freedom in design is significantly limited.

### SUMMARY

It is therefore an object of the present invention to provide an antenna device capable of performing proper communication even through it is covered by a metal layer and a portable wireless device provided with the antenna device.

An antenna device according to the present invention includes a metal layer, a substrate, and a solenoid coil wound around the substrate. At least a part of a spiral coil is formed by a conductor pattern constituting the solenoid coil, and at least a part of the spiral coil is covered by the metal layer.

A portable wireless device according to the present invention is provided with the above antenna device.

According to the present invention, the spiral and solenoid coils are combined, so that magnetic flux can be absorbed by the spiral coil through the solenoid coil. Thus, proper communication can be performed even the antenna device is covered by the metal layer. Further, even when the metal layer constitutes a part of a casing of the portable wireless device, restriction on the arrangement position of the antenna device is reduced.

In the present invention, the spiral coil is preferably positioned on the side opposite the metal layer with respect to the substrate. With this configuration, most of the magnetic flux that is absorbed by the solenoid coil after bypassing the metal layer passes the spiral coil, allowing the communication distance to be extended.

The antenna device according to the present invention preferably further includes a magnetic member disposed in the inner diameter portion of the solenoid coil. With this configuration, a larger amount of magnetic flux is absorbed by the solenoid coil, allowing communication distance to be extended.

In the present invention, it is preferable that the substrate has a polygonal region defined by the inner diameter portion of the spiral coil and that the solenoid coil is disposed along a first side constituting the polygonal region. In this case, it is preferable that the polygonal region has a second side along which no solenoid coil is disposed and that the distance between the first side and an end portion of the metal layer corresponding to the first side in a plan view is smaller than the distance between the second side and an end portion of the metal layer corresponding to the second side. With this configuration, the distance between the solenoid coil and an end portion of the metal layer corresponding to the side along which the solenoid coil is disposed is reduced, so that more magnetic flux can be absorbed by the solenoid coil.

In the present invention, the metal layer may cover the entire spiral coil. In this case, a slit or the like need not be formed in the metal layer, and the degree of freedom in arrangement position of the antenna device becomes high. Alternatively, a slit may be formed in the metal layer, and the slit may overlap the inner diameter portion of the spiral coil in a plan view. In this case, the metal layer functions as an accelerator that strengthens magnetic flux, allowing the communication distance to be significantly extended.

As described above, according to the present invention, proper communication can be performed even though the antenna device is covered by the metal layer.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a schematic plan view illustrating a configuration of an antenna device according to a first embodiment of the present invention;

FIG. 2A is a schematic cross-sectional view taken along line A-A of FIG. 1;

FIG. 2B is a schematic cross-sectional view taken along line B-B of FIG. 1;

FIG. 3 is a schematic cross-sectional view illustrating a first example of a configuration in which a magnetic member is added to the antenna device shown in FIG. 1;

FIG. 4 is a schematic cross-sectional view illustrating a second example of a configuration in which a magnetic member is added to the antenna device shown in FIG. 1;

FIG. 5 is a schematic cross-sectional view illustrating a third example of a configuration in which a magnetic member is added to the antenna device shown in FIG. 1;

FIG. 6 is a schematic cross-sectional view illustrating a fourth example of a configuration in which a magnetic member is added to the antenna device shown in FIG. 1;

FIG. 7 is a plan view illustrating an example in which the number of turns of the solenoid coils is increased;

FIG. 8 is a plan view illustrating an example in which the number of turns of the spiral coil is increased;

FIG. 9 is a schematic plan view illustrating a configuration of an antenna device according to a second embodiment of the present invention;

FIG. 10 is a plan view for explaining a preferred positional relationship between a substrate and a metal layer in the second embodiment;

FIG. 11 is a schematic plan view illustrating a configuration of an antenna device according to a third embodiment of the present invention;

FIG. 12 is a plan view for explaining a preferred positional relationship between a substrate and a metal layer in the third embodiment;

FIG. 13 is a schematic plan view illustrating a configuration of an antenna device according to a fourth embodiment of the present invention;

FIG. 14 is a plan view for explaining a preferred positional relationship between a substrate and a metal layer in the fourth embodiment;

FIG. 15 is a schematic plan view illustrating a configuration of an antenna device according to a fifth embodiment of the present invention;

FIG. 16 is a plan view for explaining a preferred positional relationship between a substrate and a metal layer in the fifth embodiment;

FIG. 17 is a schematic plan view illustrating a configuration of an antenna device according to a sixth embodiment of the present invention; and

FIG. 18 is a schematic plan view illustrating a configuration of an antenna device according to a seventh embodiment of the present invention.

### DETAILED DESCRIPTION OF THE EMBODIMENTS

Preferred embodiments of the present invention will be explained below in detail with reference to the accompanying drawings.

### First Embodiment

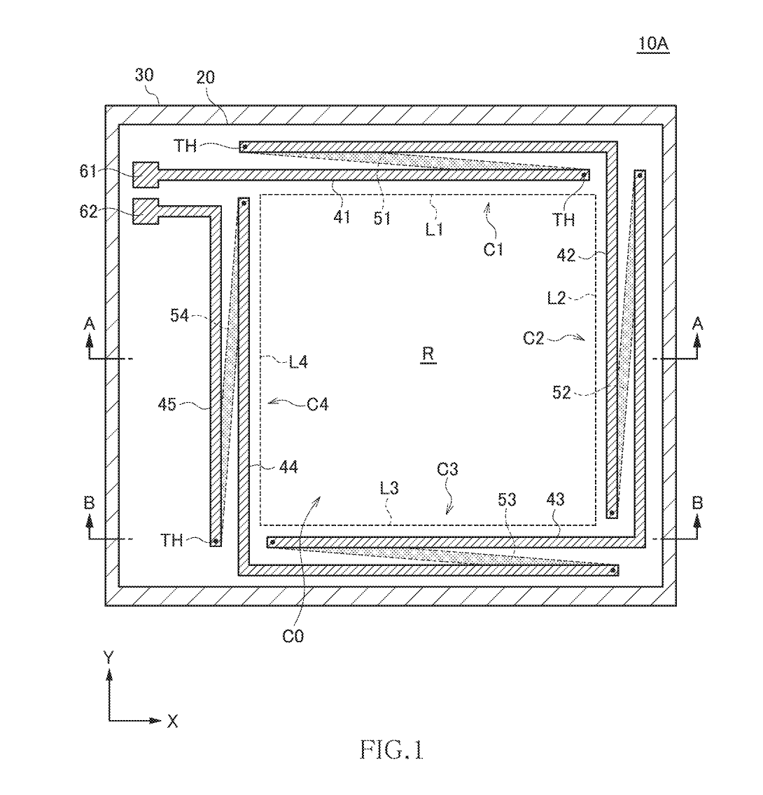

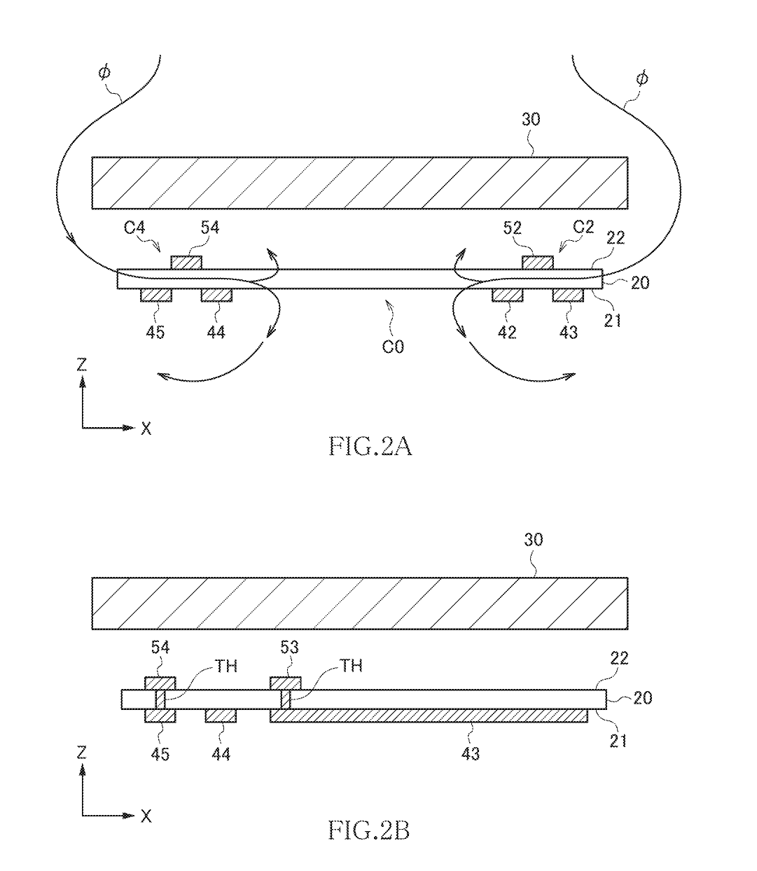

FIG. 1 is a schematic plan view illustrating a configuration of an antenna device 10A according to the first embodiment of the present invention. FIG. 2A is a schematic cross-sectional view taken along line A-A of FIG. 1, and FIG. 2B is a schematic cross-sectional view taken along line B-B of FIG. 1.

As illustrated in FIG. 1, FIG. 2A, and FIG. 2B, the antenna device 10A according to the present embodiment includes a substrate 20 made of PET resin, a metal layer 30 covering the substrate 20, conductor patterns 41 to 45 formed on one surface 21 of the substrate 20, and conductor patterns 51 to 54 formed on the other surface 22 of the substrate 20.

As illustrated in FIG. 1 and FIG. 2B, a predetermined end portion of each of the conductor patterns 41 to 45 and a predetermined end portion of each of the conductor patterns 51 to 54 are connected to each other by through hole conductors TH formed so as to penetrate the substrate 20. For example, one end of the conductor pattern 51 is connected to one end of the conductor pattern 41 by the through hole conductor TH, and the other end of the conductor pattern 51 is connected to one end of the conductor pattern 42 by the through hole conductor TH.

As illustrated in FIG. 1, the conductor patterns 41 to 45 each have a part extending in the X-direction, and end portions in the X-direction thereof are connected by the conductor pattern 51 or 53. For example, the right end portion of the conductor pattern 41 is connected to the left end portion of the conductor pattern 42 through the conductor pattern 51, and the left end portion of the conductor pattern 43 is connected to the right end portion of the conductor pattern 44 through the conductor pattern 53.

Further, the conductor patterns 42 to 45 each have a part extending in the Y-direction, and end portions in the Y-direction thereof are connected by the conductor pattern 52 or 54. For example, the lower end portion of the conductor pattern 42 is connected to the upper end portion of the conductor pattern 43 through the conductor pattern 52, and the upper end portion of the conductor pattern 44 is connected to the lower end portion of the conductor pattern 45 through the conductor pattern 54.

The end portions of the conductor patterns 41 and 45 constitute terminal electrodes 61 and 62 of the antenna device 10A, respectively. The terminal electrodes 61 and 62 are connected to an unillustrated RF circuit incorporated in a portable wireless device. With this configuration, the antenna device 10A according to the present embodiment can be used for near field wireless communication where data is transmitted/received at a frequency of, e.g., 13.56 MHz.

The metal layer 30 is, e.g., a casing of a portable wireless device incorporating the antenna device 10A and covers the entire substrate 20 in the present embodiment. Particularly, in the present embodiment, the other surface 22 of the substrate 20 faces the metal layer 30. In other words, the conductor patterns 41 to 45 are positioned on the side opposite the metal layer 30 with respect to the substrate 20.

With such a configuration, one spiral coil C0 and four solenoid coils C1 to C4 are formed, and these coils are covered by the metal layer 30. The spiral coil C0 is a planar coil having a quadrangular region Ras an inner diameter part. The solenoid coils C1 to C4 are disposed along the respective four sides L1 to L4 constituting the region R. In the present embodiment, the region R has a substantially square shape, but not particularly limited thereto.

The spiral coil C0 is constituted of the conductor patterns 41 to 45, and the winding direction thereof is the clockwise direction as viewed from the one surface 21 when the terminal electrode 61 is regarded as the winding start point.

The solenoid coil C1 is constituted of the conductor patterns 41 and 51 that extend in the X-direction, a part of the conductor pattern 42 that extends in the X-direction, and the through hole conductors TH connecting them and wounded around the substrate 20 one and half turns. The winding direction of the solenoid coil C1 is the clockwise direction as viewed from the region R when the terminal electrode 61 is regarded as the winding start point.

The solenoid coil C2 is constituted of parts of the respective conductor patterns 42 and 43 that extend in the Y-direction, the conductor pattern 52 that extends in the Y-direction, and the through hole conductors TH connecting them and wounded around the substrate 20 one and half turns. The winding direction of the solenoid coil C2 is the clockwise direction as viewed from the region R when the terminal electrode 61 is regarded as the winding start point.

The solenoid coil C3 is constituted of parts of the respective conductor patterns 43 and 44 that extend in the X-direction, the conductor pattern 53 that extends in the X-direction, and the through hole conductors TH connecting them and wounded around the substrate 20 one and half turns.

The winding direction of the solenoid coil C3 is the clockwise direction as viewed from the region R when the terminal electrode 61 is regarded as the winding start point.

The solenoid coil C4 is constituted of parts of the respective conductor patterns 44 and 45 that extend in the Y-direction, the conductor pattern 54 that extends in the Y-direction, and the through hole conductors TH connecting them and wounded around the substrate 20 one and half turns. The winding direction of the solenoid coil C4 is the clockwise direction as viewed from the region R when the terminal electrode 61 is regarded as the winding start point.

As described above, the four solenoid coils C1 to C4 are wound in the same direction as viewed from the region R.

Therefore, as illustrated in FIG. 2A, when magnetic flux φ generated from a reader/writer reaches the vicinity of the substrate 20 after bypassing the metal layer 30, it is absorbed in the region R through the four solenoid coils C1 to C4, thereby inducing current. The current flows in the solenoid coils C1 to C4 in the same direction, so that current flows between the terminal electrodes 61 and 62, and a signal component superimposed on the current is received by an unillustrated RF circuit.

In addition, as illustrated in FIG. 2A, most of the magnetic flux φ that is absorbed by the solenoid coils C1 to C4 passes the one surface 21 side of the substrate 20 to take a turn, so that current is induced by the spiral coil C0 constituted of the conductor patterns 41 to 45, as well. The current generated by the spiral coil C0 strengthens the current generated by the solenoid coil C1 to C4, so that more current flows between the terminal electrodes 61 and 62.

As illustrated in FIG. 2A, part of the magnetic flux φ that is absorbed by the solenoid coils C1 to C4 passes the other surface 22 side of the substrate 20, i.e., the metal layer 30 side to take a turn. Considering this point, a configuration may be adopted, in which the substrate 20 is turned over so as to position the conductor patterns 41 to 45 on the metal layer 30 side as viewed from the substrate 20.

Thus, the magnetic flux 0 bypassing the metal layer 30 is efficiently converted into current, so that proper communication can be performed even though the entire surface of the substrate 20 is covered by the metal layer 30.

The current flowing direction in the conductor patterns 51 to 54 on the other surface 22 side is opposite the direction of current flow in the conductor patterns 41 to 45, so that the conductor patterns 51 to 54 act in the direction canceling the magnetic flux generated by the spiral coil C0. However, current flows in the same direction in two of three conductor patterns provided along each of the sides L1 to L4, and opposite-direction current flows in the remaining one conductor patterns. That is, the current flowing in the same direction prevails, and thus the spiral coil C0 functions properly.

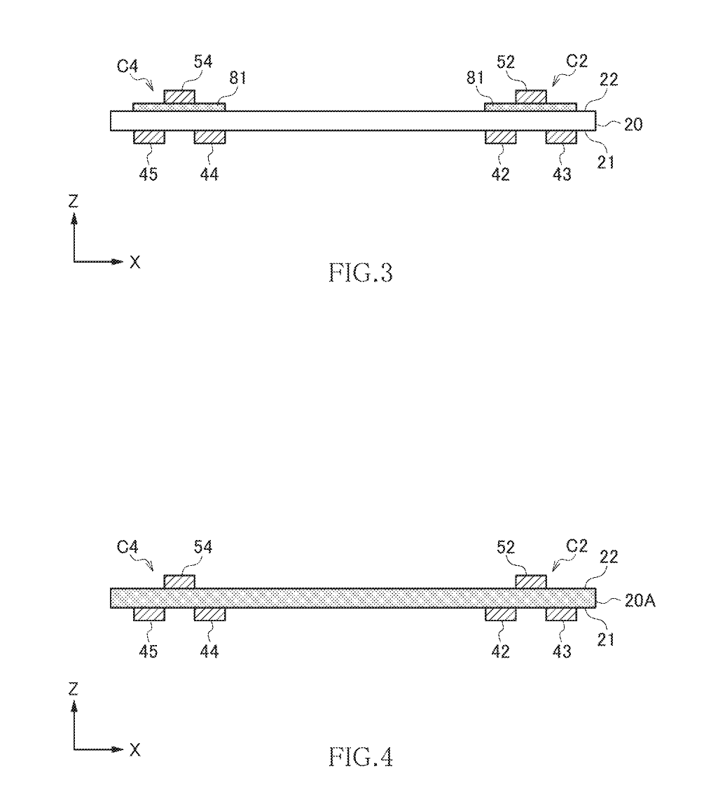

FIGS. 3 to 6 are cross-sectional views each illustrating an example of a configuration in which a magnetic member is added to the antenna device 10A.

FIG. 3 illustrates the first example in which a magnetic member 81 is selectively disposed at the inner diameter portion of each of the solenoid coils C1 to C4. When the magnetic member 81 is disposed at the inner diameter portion of each of the solenoid coils C1 to C4, a greater amount of magnetic flux is absorbed by the solenoid coils C1 to C4, allowing the communication distance to be extended. In the example of FIG. 3, the magnetic member 81 is provided on the other surface 21 side of the substrate 20; alternatively, however, the magnetic member 81 may be provided on the one surface 21 side of the substrate 20 or on both the one surface 21 side and other surface 22 side.

FIG. 4 illustrates the second example in which a magnetic resin sheet 20A is used in place of the substrate 20 made of PET resin. The magnetic resin sheet 20A is a sheet-like magnetic member that functions as a substrate that supports the conductor patterns 41 to 45 and 51 to 54 and as a magnetic path. The magnetic resin sheet 20A is obtained by processing magnetic metal powder-containing resin into a sheet. The magnetic metal powder-containing resin is obtained by dispersing magnetic metal powder in a resin binder.

As the soft magnetic metal powder, permalloy (Fe—Ni alloy), super permalloy (Fe—Ni—Mo alloy), Sendust (Fe—Si—Al alloy), Fe—Si alloy, Fe—Co alloy, Fe—Cr alloy, Fe—Cr—Si alloy or the like can be used. As the resin binder, phenol resin, urea resin, melamine resin, polytetrafluoroethylene, polyethylene, polypropylene, polystyrene, polyether sulfone, polyphenylene sulfide, PET (polyethylene terephthalate), PBT (polybutylene terephthalate), polyarylate, silicone resin, diallyl phthalate, polyimide, or the like can be used. The magnetic metal powder preferably has a flat shape with a high aspect ratio. When the flat-shaped metal powder with high aspect ratio is used, particles of the flat-shaped metal powder overlap each other in the sheet thickness direction. This enhances effective permeability in the surface direction of the magnetic resin sheet.

According to the present example, the magnetic resin sheet 20A itself constitutes the substrate, making it possible to extend the communication distance without increasing the number of components.

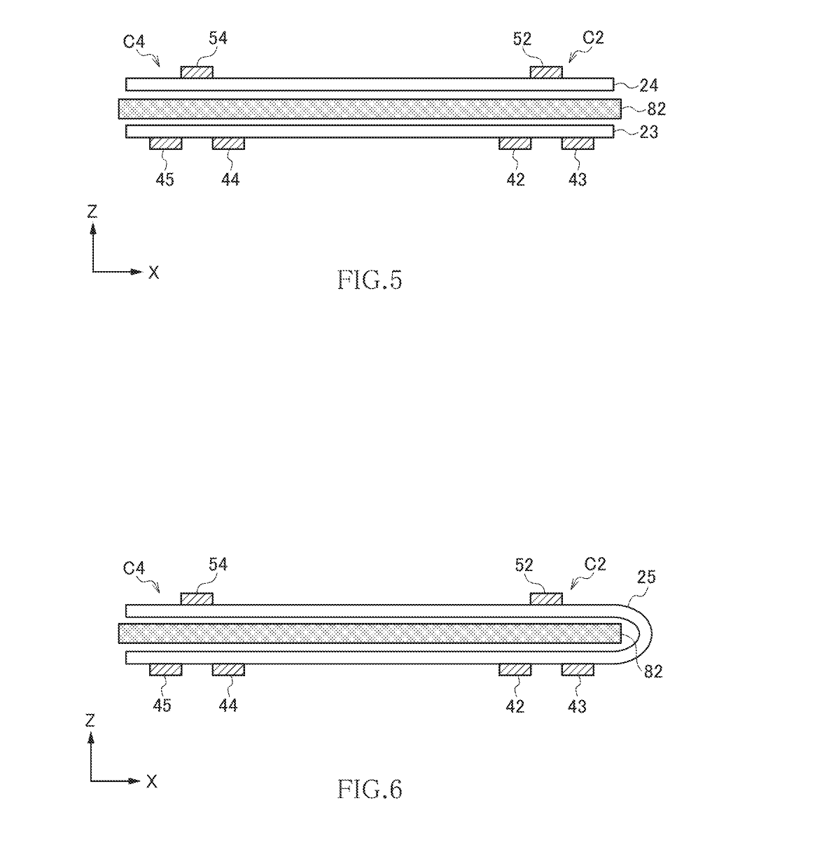

FIG. 5 illustrates the third example in which the conductor patterns 41 to 45 are formed on a resin substrate 23, the conductor patterns 51 to 54 are formed on another resin substrate 24, and a magnetic member 82 is sandwiched between the resin substrates 23 and 24. As a material for the resin substrates 23 and 24, PET resin can be used. As a material for the magnetic member 82, plate-like ferrite or the like can be used. Even in such a configuration, the same effects as in the example of FIG. 4 can be obtained. Further, in the present example, since the magnetic member is not used as the substrate, any magnetic material can be used as the magnetic member 82.

FIG. 6 illustrates the fourth example in which a single resin substrate 25 is folded so as to sandwich the magnetic member 82. Even when the single resin substrate 25 is used, the magnetic member 82 can be sandwiched by folding the single resin substrate 25.

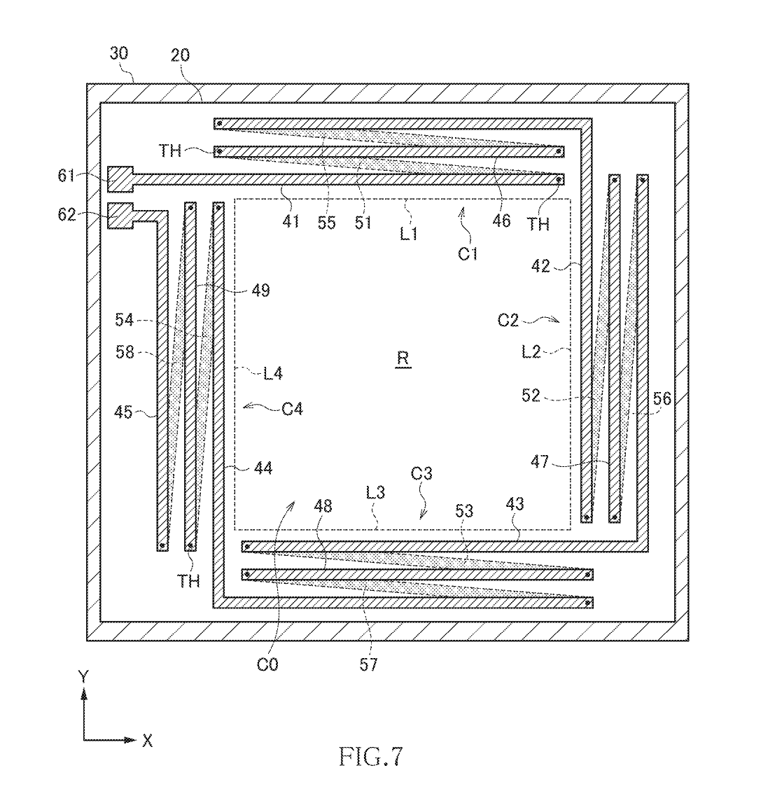

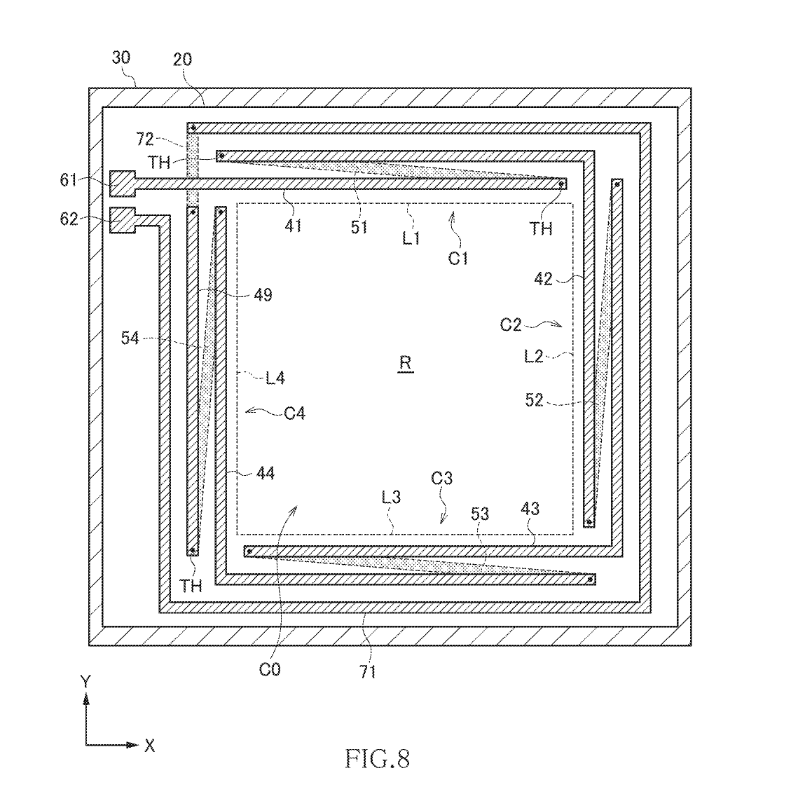

FIGS. 7 and 8 are plan views each illustrating an example in which the number of turns of the spiral coil C0 or solenoid coils C1 to C4 is increased.

In the example of FIG. 7, conductor patterns 46 to 49 and 55 to 58 are added to constitute solenoid coils C1 to C4 each wounded around two and half turns. The conductor patterns 46 to 49 are formed on the one surface 21 side of the substrate 20, and the conductor patterns 55 to 58 are formed on the other surface 22 side of the substrate 20.

As described above, the number of turns of each of the solenoid coils C1 to C4 is not particularly limited and may be set to two and half as illustrated in FIG. 7 or more. Further, the numbers of turns of the respective solenoid coils C1 to C4 need not necessarily be the same, and some or all of the numbers of turns may differ from each other. For example, the number of turns of each of the solenoid coils C1 and C3 may be two and half, and that of each of the solenoid coils C2 and C4 may be one and half. That is, the number of turns may be set in accordance with characteristics or conditions required.

In the example of FIG. 8, a spiral conductor pattern 71 is added so as to be disposed at the outer periphery of the solenoid coils C1 to C4. The conductor pattern 71 constitutes a one-turn spiral, and one end thereof is connected to a conductor pattern 49 through the through hole conductors TH and the conductor pattern 72 on the other surface 22 side of the substrate 20. The other end of the conductor pattern 71 is connected to the terminal electrode 62.

Adding such a spiral conductor pattern 71 increases inductance and, hence, the communication distance can be extended. That is, in the example of FIG. 8, current flows in the same direction in three of four conductor patterns provided along each of the sides L1 to L4, and opposite-direction current flows in the remaining one conductor pattern. That is, the current flowing in the same direction prevails. The number of turns of the spiral conductor pattern to be added is not particularly limited and may be two or more or less than one (e.g., half turn). Further, the spiral conductor pattern to be added need not necessarily be formed at the outer periphery of the solenoid coils C1 to C4, but may be formed at the inner periphery thereof.

As described above, in the antenna device 10A according to the present embodiment, the solenoid coils C1 to C4 are formed along the sides L1 to L4, respectively, so that magnetic flux bypassing the metal layer 30 can be absorbed from all the surface directions, and the absorbed magnetic flux can be supplied to the spiral coil C0. Thus, proper communication can be performed even though the entire surface of the substrate 20 is covered by the metal layer 30.

### Second Embodiment

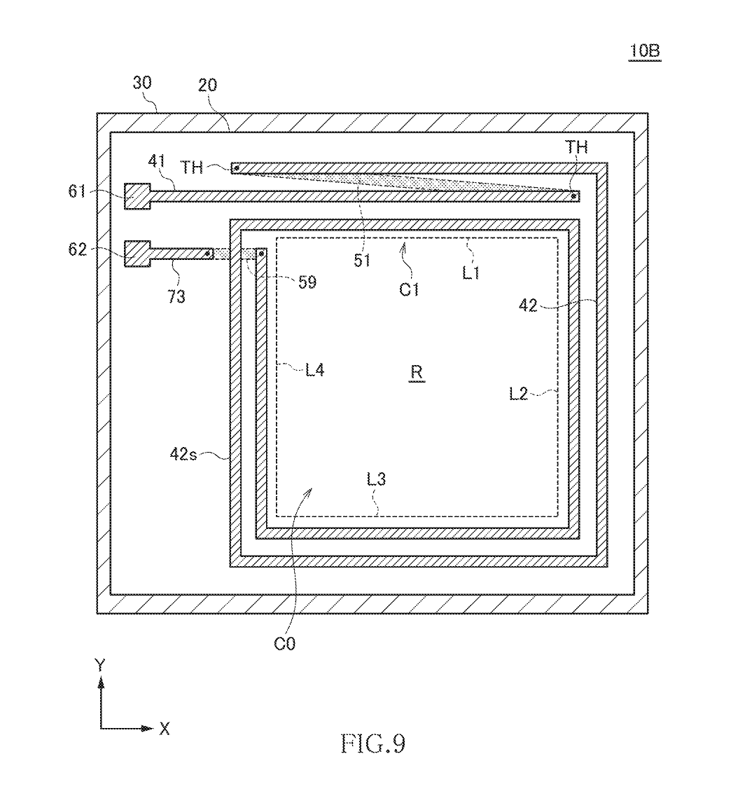

FIG. 9 is a schematic plan view illustrating a configuration of an antenna device 10B according to the second embodiment of the present invention.

As illustrated in FIG. 9, the antenna device 10B according to the present embodiment differs from the antenna device 10A according to the first embodiment in that the solenoid coils C2 to C4 are omitted. Specifically, while the constituent elements constituting the solenoid coil C1 are the same as those in the antenna device 10A according to the first embodiment, the conductor patterns 43 to 45 and 52 to 54 constituting the solenoid coils C2 to C4 are omitted and, instead, the conductor pattern 42 itself has a spiral part 42s. The inner peripheral end of the spiral part 42s is connected to a conductor pattern 73 through the through hole conductors TH and a conductor pattern 59 on the other surface 22 side of the substrate 20. The conductor pattern 73 is connected to the terminal electrode 62.

As described above, in the present invention, the solenoid coils C1 to C4 need not necessarily be formed along all the sides L1 to L4 of the region R as the inner diameter part of the spiral coil C0, and a solenoid coil (C1) may be formed only along some sides (in the present embodiment, L1) of the region R. In this case, capability to take in magnetic flux is reduced because of reduction in the number of the solenoid coils; however, a part (conductor patterns 51 to 54 illustrated in FIG. 1) that cancels current generated by the spiral coil is reduced, enabling the characteristics of the spiral coil to be enhanced.

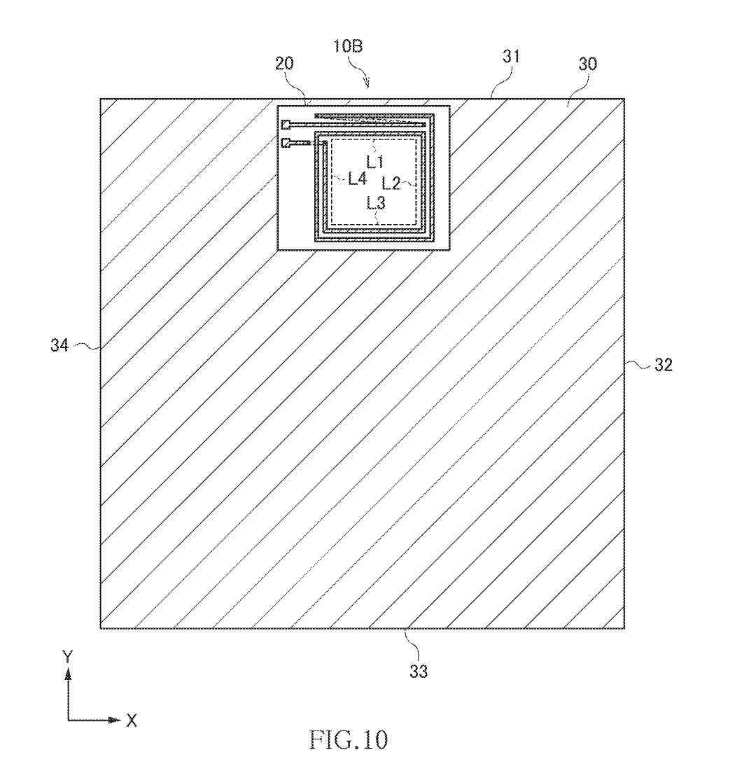

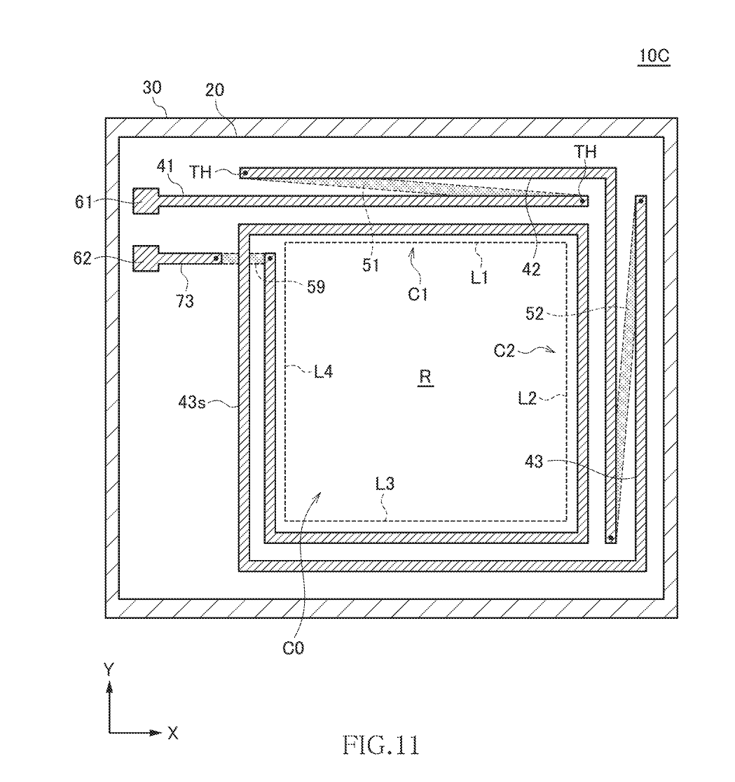

FIG. 10 is a plan view for explaining a preferred positional relationship between the substrate 20 and the metal layer 30 in the second embodiment.

As illustrated in FIG. 10, in the present embodiment, the substrate 20 is disposed so as to be offset with respect to the metal layer 30 in the Y-direction. Specifically, the side L1 along which the solenoid coil C1 is formed is positioned in the vicinity of the corresponding end portion 31 of the metal layer 30. The end portion 31 is one end portion extending in the X-direction and closest to the side L1 along which the solenoid coil C1 is formed. Thus, the distance between the side L1 and the end portion 31 of the metal layer 30 is smaller than distances between the other sides L2 to L4 and respective other end portions 32 to 34 of the metal layer 30. The end portion 32 is one end portion extending in the Y-direction, the end portion 33 is the other end portion extending in the X-direction, and the end portion 34 is the other end portion extending in the Y-direction. By adopting the above layout, magnetic flux bypassing the metal layer 30 is efficiently absorbed by the solenoid coil C1, so that proper communication can be performed even though the number of the solenoid coils is small (one).

### Third Embodiment

FIG. 11 is a schematic plan view illustrating a configuration of an antenna device 10C according to the third embodiment of the present invention.

As illustrated in FIG. 11, the antenna device 10C according to the present embodiment differs from the antenna device 10A according to the first embodiment in that the solenoid coils C3 and C4 are omitted. Specifically, while the constituent elements constituting the solenoid coils C1 and C2 are the same as those in the antenna device 10A according to the first embodiment, the conductor patterns 44, 45, 53, and 54 constituting the solenoid coils C3 and C4 are omitted and, instead, the conductor pattern 43 itself has a spiral part 43s. The inner peripheral end of the spiral part 43s is connected to the conductor pattern 73 through the through hole conductors TH and the conductor pattern 59 on the other surface 22 side of the substrate 20.

As described above, in the present invention, the solenoid coils C1 and C2 are formed along the two sides L1 and L2, respectively. In the present invention as well, capability to take in magnetic flux is reduced as compared with the antenna device 10A according to the first embodiment owing to reduction in the number of the solenoid coils; however, a part (conductor patterns 51 to 54 illustrated in FIG. 1) that cancels current generated by the spiral coil is reduced, thus enabling the characteristics of the spiral coil to be enhanced.

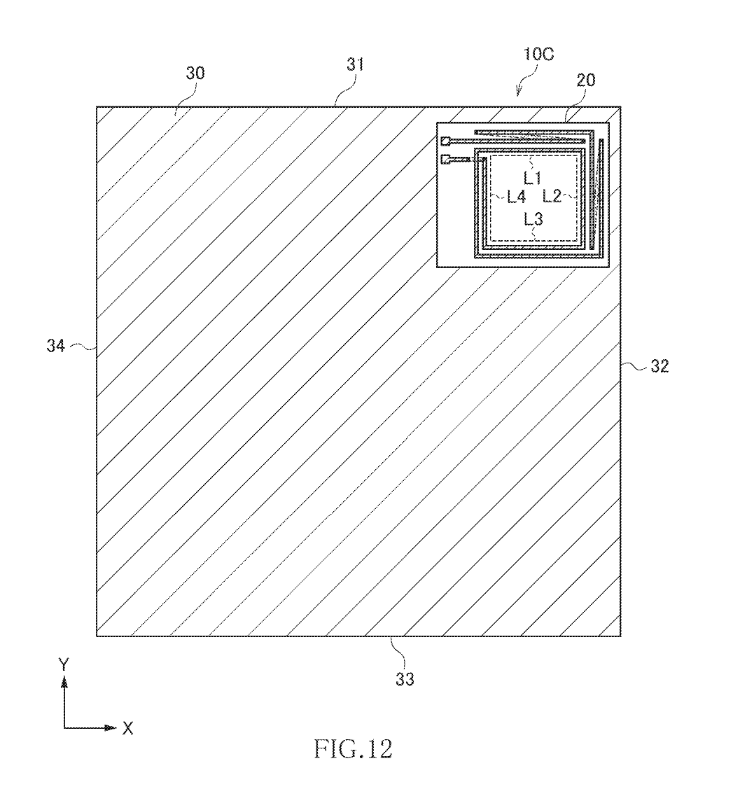

FIG. 12 is a plan view for explaining a preferred positional relationship between the substrate 20 and the metal layer 30 in the third embodiment.

As illustrated in FIG. 12, in the present embodiment, the substrate 20 is disposed in the vicinity of the corner portion of the metal layer 30. Specifically, the side L1 along which the solenoid coil C1 is formed is positioned in the vicinity of the end portion 31 of the metal layer 30, and the side L2 along which the solenoid coil C2 is formed is positioned in the vicinity of the end portion 32 of the metal layer 30. Thus, the distance between the side L1 and the end portion 31 of the metal layer 30 and the distance between the side L2 and the end portion 32 of the metal layer 30 are smaller than the distances between the other sides L3 and L4 and the respective other end portions 33 and 34 of the metal layer 30. By adopting the above layout, magnetic flux bypassing the metal layer 30 is efficiently absorbed by the solenoid coils C1 and C2, so that proper communication can be performed even though the number of the solenoid coils is small (two).

### Fourth Embodiment

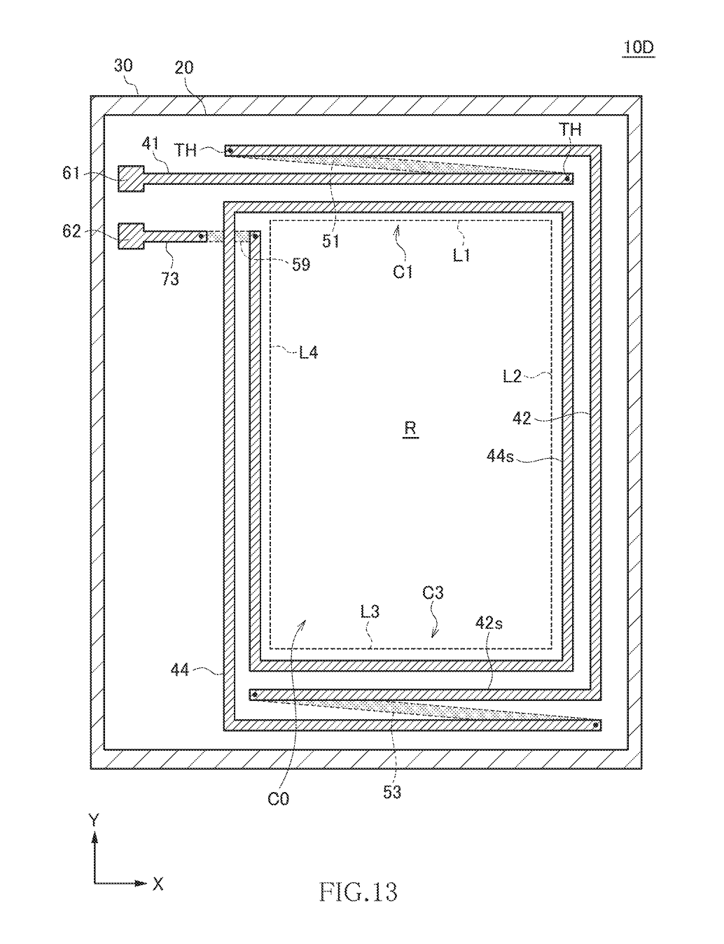

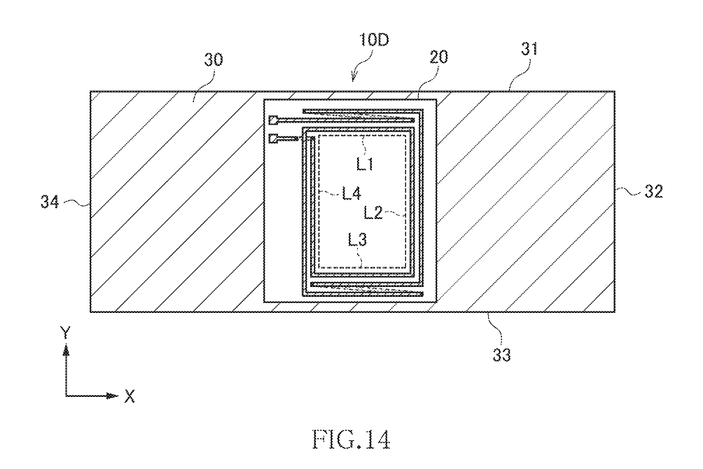

FIG. 13 is a schematic plan view illustrating a configuration of an antenna device 10D according to the fourth embodiment of the present invention.

As illustrated in FIG. 13, the antenna device 10D according to the present embodiment differs from the antenna device 10A according to the first embodiment in that the region R has a rectangular shape elongated in the Y-direction and that the solenoid coils C2 and C4 are omitted. Specifically, while the constituent elements constituting the solenoid coils C1 and C3 are the same as those in the antenna device 10A according to the first embodiment, the conductor patterns 43, 45, 52, and 54 constituting the solenoid coils C2 and C4 are omitted and, instead, the conductor patterns 42 and 44 themselves have spiral parts 42s and 44s, respectively. The inner peripheral end of the spiral part 42s is connected to the conductor pattern 53 on the other surface 22 side of the substrate 20 through the through hole conductors TH. The inner peripheral end of the spiral part 44s is connected to the conductor pattern 73 through the through hole conductors TH and the conductor pattern 59 on the other surface 22 side of the substrate 20.

As described above, in the present embodiment, the solenoid coils C1 and C3 are formed along the two short sides L1 and L3, respectively. In the present invention as well, capability to take in magnetic flux is reduced as compared with the antenna device 10A according to the first embodiment because of reduction in the number of the solenoid coils; however, a part (conductor patterns 51 to 54 illustrated in FIG. 1) that cancels current generated by the spiral coil is reduced, thus enabling the characteristics of the spiral coil to be enhanced.

FIG. 14 is a plan view for explaining a preferred positional relationship between the substrate 20 and the metal layer 30 in the fourth embodiment.

As illustrated in FIG. 14, in the present embodiment, the metal layer 30 has a shape elongated in the X-direction, and the width of the metal layer 30 in the Y-direction is slightly larger than the width of the substrate 20 in the Y-direction. Thus, the side L1 along which the solenoid coil C1 is formed is positioned in the vicinity of the end portion 31 of the metal layer 30, and the side L3 along which the solenoid coil C3 is formed is positioned in the vicinity of the end portion 33 of the metal layer 30. As a result, the distance between the side L1 and the end portion 31 of the metal layer 30 and the distance between the side L3 and end portion 33 of the metal layer 30 are smaller than the distances between the other sides L2 and L4 and the respective other end portions 32 and 34 of the metal layer 30. By adopting the above layout, magnetic flux bypassing the metal layer 30 in the Y-direction is efficiently absorbed by the solenoid coils C1 and C3, so that proper communication can be performed even though the number of the solenoid coils is small (two).

### Fifth Embodiment

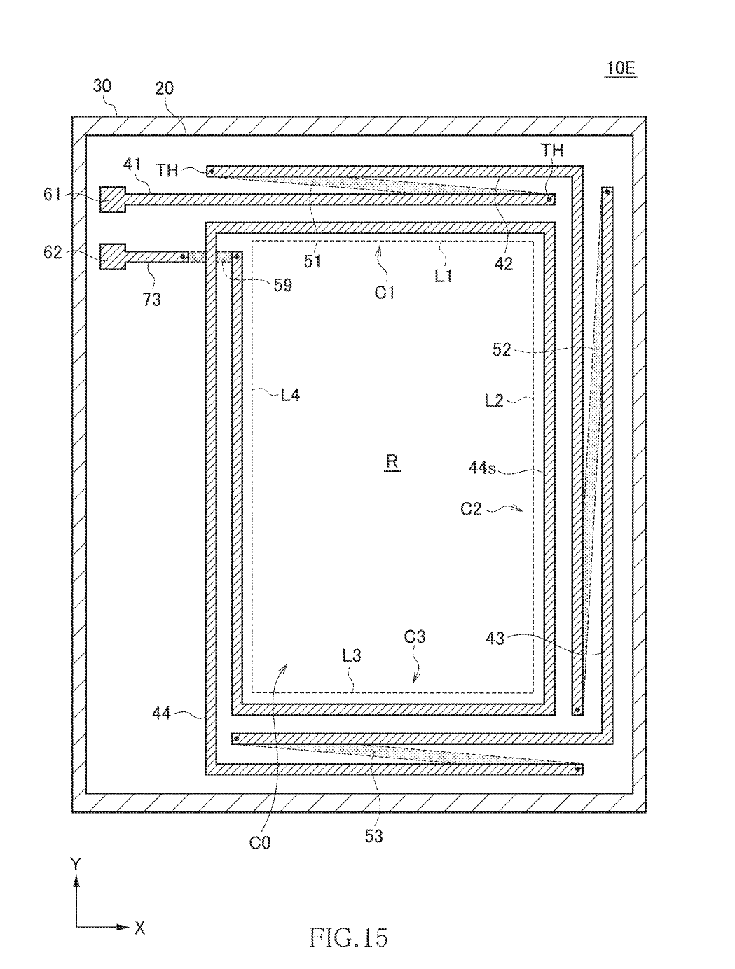

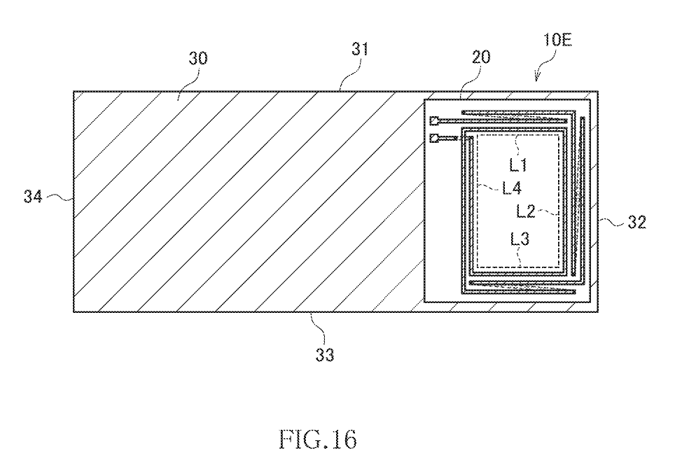

FIG. 15 is a schematic plan view illustrating a configuration of an antenna device 10E according to the fifth embodiment of the present invention.

As illustrated in FIG. 15, the antenna device 10E according to the present embodiment differs from the antenna device 10A according to the first embodiment in that the region R has a rectangular shape elongated in the Y-direction and that the solenoid coil C4 is omitted. Specifically, while the constituent elements constituting the solenoid coils C1 to C3 are the same as those in the antenna device 10A according to the first embodiment, the conductor patterns 45 and 54 constituting the solenoid coil C4 are omitted and, instead, the conductor pattern 44 itself has a spiral part 44s. The inner peripheral end of the spiral part 44s is connected to the conductor pattern 73 through the through hole conductors TH and the conductor pattern 59 on the other surface 22 side of the substrate 20.

As described above, in the present embodiment, the solenoid coils C1 to C3 are formed along the three sides L1 to L3, respectively. In the present embodiment as well, capability to take in magnetic flux is reduced as compared with the antenna device 10A according to the first embodiment because of reduction in the number of the solenoid coils; however, a part (conductor patterns 51 to 54 illustrated in FIG. 1) that cancels current generated by the spiral coil is reduced, thus enabling the characteristics of the spiral coil to be enhanced.

FIG. 16 is a plan view for explaining a preferred positional relationship between the substrate 20 and the metal layer 30 in the fifth embodiment.

As illustrated in FIG. 16, in the present embodiment, the metal layer 30 has a shape elongated in the X-direction, the width of the metal layer 30 in the Y-direction is slightly larger than the width of the substrate 20 in the Y-direction, and the substrate 20 is disposed so as to be offset in the X-direction. Thus, the side L1 along which the solenoid coil C1 is formed is positioned in the vicinity of the end portion 31 of the metal layer 30, the side L2 along which the solenoid coil C2 is formed is positioned in the vicinity of the end portion 32 of the metal layer 30, and the side L3 along which the solenoid coil C3 is formed is positioned in the vicinity of the end portion 33 of the metal layer 30. As a result, the distance between the side L1 and the end portion 31 of the metal layer 30, the distance between the side L2 and end portion 32 of the metal layer 30, and the distance between the side L3 and end portion 33 of the metal layer 30 are smaller than the distance between the other side L4 and the other end portion 34 of the metal layer 30. By adopting the above layout, the magnetic flux bypassing the metal layer 30 in the Y-direction and the magnetic flux bypassing the metal layer 30 from one side (right side in FIG. 16) in the X-direction are efficiently absorbed by the solenoid coils C1 to C3, so that proper communication can be performed even though the number of the solenoid coils is small (three).

### Sixth Embodiment

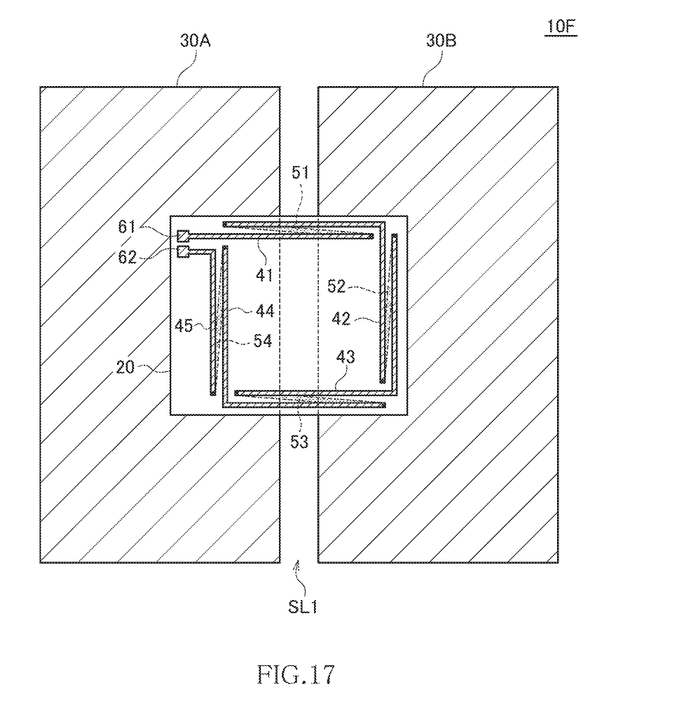

FIG. 17 is a schematic plan view illustrating a configuration of an antenna device 10F according to the sixth embodiment of the present invention.

As illustrated in FIG. 17, the antenna device 10F according to the present embodiment differs from the antenna device 10A according to the first embodiment in that two metal layers 30A and 30B are used. The metal layers 30A and 30B are arranged in the X-direction, whereby a slit SL1 extending in the Y-direction is formed. The slit SL1 is formed so as to cross the inner diameter portion of the spiral coil C0, whereby the slit SL1 and the inner diameter portion of the spiral coil C0 overlap each other in a plan view. While, in the example of FIG. 17, the configuration of the conductor patterns formed on the substrate 20 is the same as that in the antenna device 10A according to the first embodiment, the same configuration of the conductor patterns in the antenna device 10B, 10C, 10D, or 10E according to the respective second, third, fourth, or fifth embodiment may be used.

With this configuration, part of the magnetic flux radiated from the reader/writer passes the slit SL1 and enters the inner diameter portion of the spiral coil C0. In addition, eddy current generated by the magnetic flux radiated from the reader/writer and enters the metal layers 30A and 30B generates new magnetic flux in the direction canceling the incident magnetic flux, and the newly generated magnetic flux enters the inner diameter portion of the spiral coil C0 through the slit SL1. As described above, the metal layers 30A and 30B each function as an accelerator that strengthens the magnetic flux and, hence, the communication distance can be significantly extended.

### Seventh Embodiment

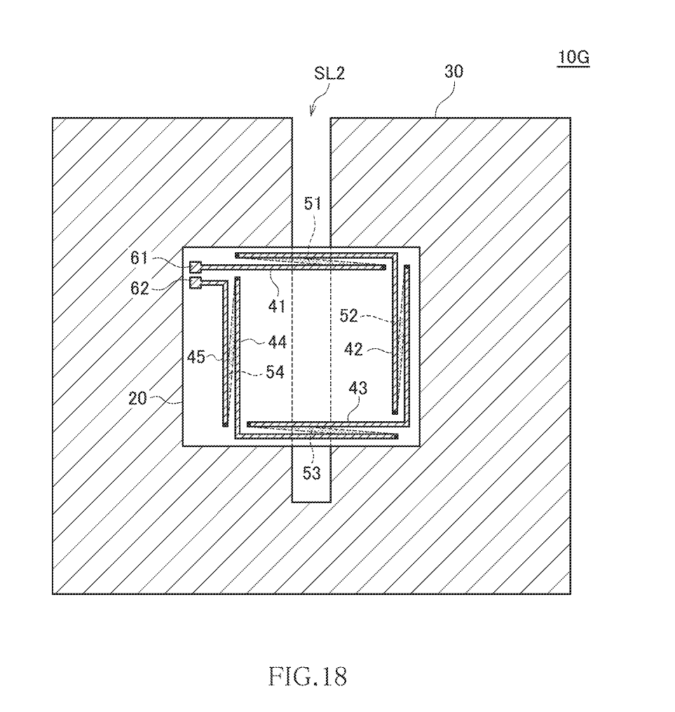

FIG. 18 is a schematic plan view illustrating a configuration of an antenna device 10G according to the seventh embodiment of the present invention.

As illustrated in FIG. 18, the antenna device 10G according to the present embodiment differs from the antenna device 10A according to the first embodiment in that a slit SL2 is formed in the metal layer 30. The slit SL2 extends in the Y-direction and crosses the inner diameter portion of the spiral coil C0, whereby the slit SL2 and the spiral coil C0 overlap each other in a plan view. While, in the example of FIG. 18, the configuration of the conductor patterns formed on the substrate 20 is the same as that in the antenna device 10A according to the first embodiment, the same configuration of the conductor patterns in the antenna device 10B, 10C, 10D, or 10E according to the respective second, third, fourth, or fifth embodiment may be used. With this configuration, the same effect as that in the above sixth embodiment can be obtained. In addition, since the metal layer 30 is not divided into two, the width of the slit SL2 in the X-direction is not varied.

It is apparent that the present invention is not limited to the above embodiments, but may be modified and changed without departing from the scope and spirit of the invention.

For example, while the spiral coil C0 has a quadrangular shape in the above embodiments, the present invention is not limited to this, and the spiral coil C0 may have a polygonal shape other than the quadrangular shape, such as a triangular, hexagonal, or octagon shape, or a circular or ellipsoidal shape. In the case of employing the spiral coil C0 having a polygonal shape other than the quadrangular shape, one or more solenoid coils should be disposed on the position connecting two corresponding vertices of a polygonal region as the inner diameter portion of the spiral coil.

What is claimed is:

1. An antenna device comprising:
a metal layer;
a substrate; and
a solenoid coil wound around the substrate,
wherein at least a part of a spiral coil is formed by a conductor pattern constituting the solenoid coil, and
wherein at least a part of the spiral coil is covered by the metal layer.

2. The antenna device as claimed in claim 1, wherein the spiral coil is positioned on opposite to the metal layer with respect to the substrate.

3. The antenna device as claimed in claim 1, further comprising a magnetic member disposed in an inner diameter portion of the solenoid coil.

4. The antenna device as claimed in claim 1, wherein the substrate has a polygonal region being defined by an inner diameter portion of the spiral coil, and wherein the solenoid coil is disposed along a first side constituting the polygonal region.

5. The antenna device as claimed in claim 4,
wherein the polygonal region has a second side along which no solenoid coil is disposed, and
wherein a distance between the first side and an end portion of the metal layer corresponding to the first side in a plan view is smaller than a distance between the second side and another end portion of the metal layer corresponding to the second side.

6. The antenna device as claimed in claim 1, wherein the metal layer entirely covers spiral coil.

7. The antenna device as claimed in claim 1,
wherein the metal layer has a slit, and
wherein the slit overlaps an inner diameter portion of the spiral coil in a plan view.

8. A portable wireless device including an antenna device, the antenna device comprising:
a metal layer;
a substrate; and
a solenoid coil wound around the substrate,
wherein at least a part of a spiral coil is formed by a conductor pattern constituting the solenoid coil, and
wherein at least a part of the spiral coil is covered by the metal layer.

9. The portable wireless device as claimed in claim 8, wherein the metal layer is a part of a casing of the portable wireless device.

10. An antenna device comprising:
a substrate having a front surface and a rear surface opposite to the front surface;
a front conductor pattern formed on the front surface of the substrate;
a rear conductor pattern formed on the rear surface of the substrate; and
a plurality of through hole conductors penetrating through the substrate to connect the front conductor pattern to the rear conductor pattern,
wherein the front conductor pattern is arranged so as to surround a polygonal region of the front surface of the substrate, thereby the front conductor pattern forms a first coil having a first coil axis substantially perpendicular to the front and rear surfaces of the substrate,
wherein the front conductor pattern includes first and second conductor patterns disposed substantially along a first side of the polygonal region,
wherein the rear conductor pattern includes a third conductor pattern disposed substantially along the first side of the polygonal region, and
wherein the through hole conductors includes a first through hole conductor connected between one end of the third conductor pattern and one end of the first conductor pattern and a second through hole conductor connected between other end of the third conductor pattern and one end of the second conductor pattern, thereby the first, second and third conductor patterns and the first and second through hole conductors form a second coil having a second coil axis substantially perpendicular to the first coil axis.

11. The antenna device as claimed in claim 10,
wherein the front conductor pattern further includes fourth and fifth conductor patterns disposed substantially along a second side of the polygonal region,
wherein the rear conductor pattern further includes a sixth conductor pattern disposed substantially along the second side of the polygonal region, and
wherein the through hole conductors further includes a third through hole conductor connected between one end of the sixth conductor pattern and one end of the fourth conductor pattern and a fourth through hole conductor connected between other end of the sixth conductor pattern and one end of the fifth conductor pattern, thereby the fourth, fifth and sixth conductor patterns and the third and fourth through hole conductors form a third coil having a third coil axis substantially perpendicular to the first coil axis.

12. The antenna device as claimed in claim 11, wherein the second coil axis crosses the third coil axis.

13. The antenna device as claimed in claim. 12, wherein the second coil axis is substantially perpendicular to the third coil axis.

14. The antenna device as claimed in claim 11, wherein the second coil axis is substantially parallel with the third coil axis.

15. The antenna device as claimed in claim. 11, further comprising a magnetic member arranged between the first and second conductor patterns and the third conductor pattern.

16. The antenna device as claimed in claim 11, further comprising a metal layer covering the front and rear conductor patterns.

17. The antenna device as claimed in claim 16, wherein the metal layer has a slit that overlaps a part of the polygonal region.
